(19) United States
(12) Patent Application Publication
(10) Pub. No.: US 2026/0044153 A1
(43) Pub. Date: Feb. 12, 2026

(54) THREE DIMENSIONAL GEOFENCE FOR VEHICLE

(71) Applicant: Textron Inc., Providence, RI (US)

(72) Inventors: Brian David Wanta, North Augusta, SC (US); Preston Sering Easley, Martinez, GA (US)

(21) Appl. No.: 18/795,922

(22) Filed: Aug. 6, 2024

(51) Int. Cl. G05D 1/617; A01D 34/00; G05D 1/247

(52) U.S. Cl. CPC G05D 1/617; G05D 1/247; A01D 34/008

(57) ABSTRACT

A vehicle system includes a vehicle and a control system. The control system is configured to monitor a location of the vehicle relative to a restricted operation area, permit unrestricted operation of the vehicle in a first mode of operation when the location of the vehicle indicates that the vehicle is located outside of the restricted operation area, and limit operation of the vehicle to a second mode of operation or a third mode of operation when the location of the vehicle indicates that the vehicle is located in the restricted operation area. The restricted operation area is defined by one or more three dimensional geofences such that operation of the vehicle is permitted or limited based on a vertical position of the vehicle relative to the three dimensional geofence.

### BACKGROUND

Vehicles are commonly used by operators around venues such as sports stadiums, multi-story developments, and golf courses to navigate around the venues. Keep-out geofences may be established around areas of the venues where the vehicles should not drive. These keep-out geofences are two dimensional and are not able to distinguish differences in elevation.

### SUMMARY

One embodiment relates to a vehicle system. The vehicle system includes a vehicle and a control system. The vehicle includes a chassis, a plurality of tractive assemblies coupled to the chassis, and a prime mover configured to drive one or more of the plurality of tractive assemblies. The control system is configured to monitor a location of the vehicle relative to a restricted operation area, permit unrestricted operation of the vehicle in a first mode of operation when the location of the vehicle indicates that the vehicle is located outside of the restricted operation area, and limit operation of the vehicle to a second mode of operation or a third mode of operation when the location of the vehicle indicates that the vehicle is located in the restricted operation area. The restricted operation area is defined by one or more three dimensional geofences such that operation of the vehicle is permitted or limited based on a vertical position of the vehicle relative to the three dimensional geofence.

Another embodiment relates to a vehicle system for controlling operation of a vehicle. The vehicle system includes one or more processing circuits comprising one or more memory devices coupled to one or more processors, the one or more memory devices configured to store instructions thereon that, when executed by the one or more processors, cause the one or more processors to monitor a location of the vehicle relative to a restricted operation area, permit unrestricted operation of the vehicle in a first mode of operation when the location of the vehicle indicates that the vehicle is located outside of the restricted operation area, and limit operation of the vehicle to a second mode of operation or a third mode of operation when the location of the vehicle indicates that the vehicle is located in the restricted operation area. The restricted operation area is defined by one or more three dimensional geofences such that operation of the vehicle is permitted or limited based on a vertical position of the vehicle relative to the three dimensional geofence.

Still another embodiment relates to a vehicle system for controlling operation of a vehicle. The vehicle system includes a non-transitory computer-readable medium having instructions stored thereon that, when executed by one or more processors, cause the one or more processors to monitor a location of the vehicle relative to a restricted operation area, permit unrestricted operation of the vehicle in a first mode of operation when the location of the vehicle indicates that the vehicle is located outside of the restricted operation area, and limit operation of the vehicle to a second mode of operation or a third mode of operation when the location of the vehicle indicates that the vehicle is located in the restricted operation area. The restricted operation area is defined by one or more three dimensional geofences such that operation of the vehicle is permitted or limited based on a vertical position of the vehicle relative to the three dimensional geofence.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIGS. 4-7 are various diagrams of a venue including one or more three dimensional geofences, according to various exemplary embodiments.

FIG. 8 is a perspective view of a golf course including a three dimensional geofence formed around a tunnel under an overpass, according to an exemplary embodiment.

FIG. 9 is a perspective view of two vehicles of FIG. 1 surrounded by a geofence, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

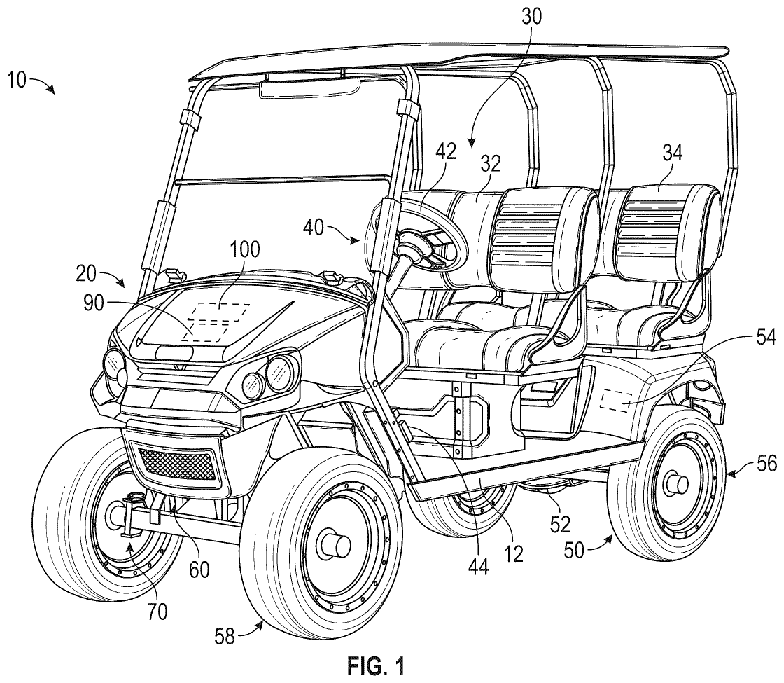

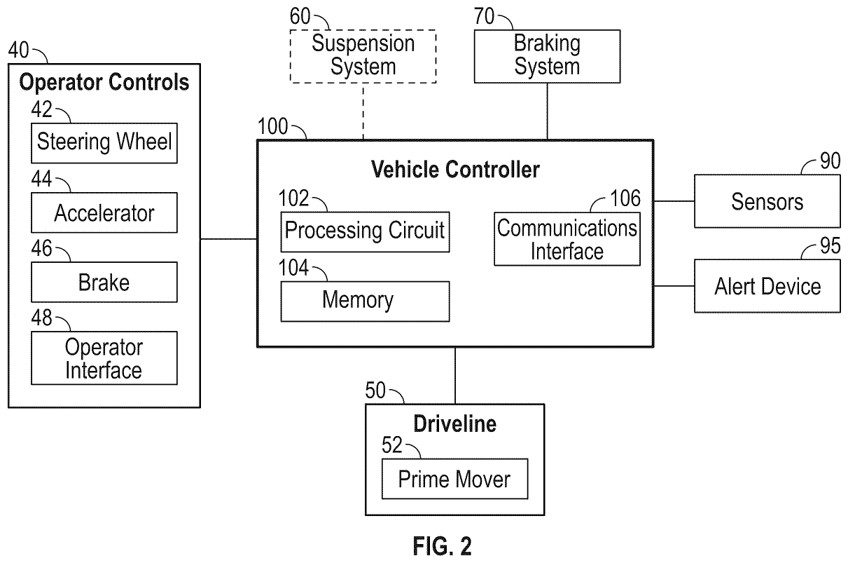

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

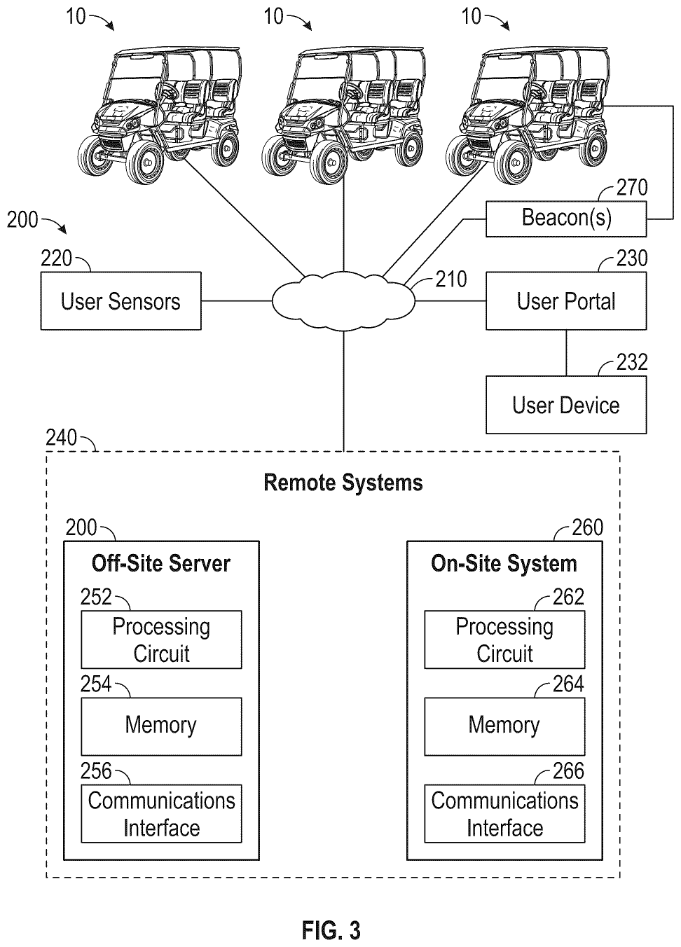

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

As shown in FIG. 3, the site monitoring and control system 200 includes one or more repeaters, shown as beacons 270, configured to facilitate transmission of signals from a first source to a second source that is out of range of the first source (or that has a weak connection with the first source). As shown in FIG. 3, the beacons 270 are configured to facilitate transmission of signals between the remote systems 240 and one or more of the vehicles 10. By way of example, (i) when the vehicles 10 are positioned far away from the remote systems 240 such that the vehicles 10 are out of range of the remote systems 240 (e.g., the communications interface 106 is out of a range of communication of the communications interface 256 and/or the communications interface 266, transmissions from the remote systems 240 are not powerful enough to reach the vehicles 10, etc.) or (ii) when a signal between the vehicles 10 and the remote systems 240 is weak due to signal interference (e.g., geomagnetic radiation), solar storms, signal obstruction (e.g., tree cover, building cover, etc.), weather (e.g., rain, snow, pressure, etc.), control system quality (e.g., range of the communications interface 106), malfunctioning sensors, and/or any other combination of technical or external factors, the beacons 270 may retransmit the signal from the remote systems 240 so that the signal is strong enough to reach the vehicles 10. Similarly, the beacons 270 may retransmit a signal from the vehicles 10 so that the signal is strong enough to reach the remote systems 240. In some embodiments, the site monitoring and control system 200 uses hierarchical communication method based on signal strength where a respective communication protocol (e.g., a communication protocol associated with GPS information transmission, a communication protocol associated with RTK information transmission, a communication protocol associated with communication via the beacons 270, etc.) between the vehicles 10 and the remote systems 240 is favored based on the strength of the signal associated with the respective communication protocol. By way of example, if a strength of the signal using the communication protocol associated with GPS information transmission and a strength of the signal using the communication protocol associated with RTK information transmission is weaker than the communication protocol associated with communication via the beacons 270, the vehicles 10 and the remote systems 240 favor and communicate using communication protocol associated with communication via the beacons 270.

### Three Dimensional Geofence

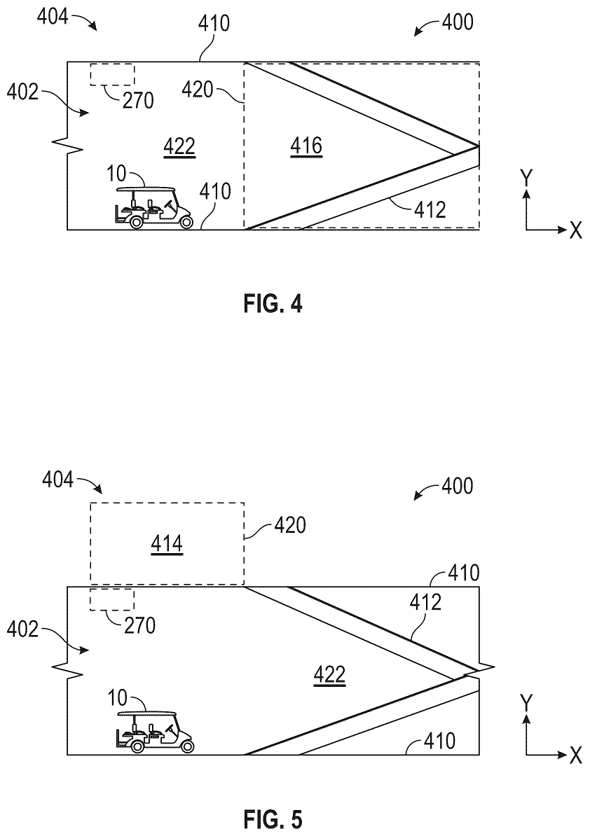

As shown in FIGS. 4-7, the vehicle 10 may be a maintenance or groundskeeping vehicle (e.g., lawn mower, aerator, turf sweeper, utility vehicle, etc.), a golf cart, an access equipment vehicle (e.g., boom lift, aerial lift, scissor lift, articulating lift, etc.), an emergency vehicle (e.g., fire truck, ambulance, police/security vehicle, etc.), an or any other vehicle utilized at a multi-level building (e.g., arena, stadium, concert hall, convention center, auditorium, etc.), shown as venue 400. As shown in FIGS. 4-7, the venue 400 includes two or more levels (e.g., floors, basements, etc.) such as a first level (e.g., first floor, ground level, etc.), shown as base level 402, a second level (e.g., second floor, upper level, etc.), shown as second level 404, vertically higher than (e.g., vertically above) the base level 402, a third level (e.g., third floor, upper level, etc.), shown as third level 406, vertically higher than (e.g., vertically above) the second level 404, and a fourth level (e.g., a basement), shown as lower level 408, vertically lower than (e.g., vertically below) the base level 402. In some embodiments, the venue 400 includes more or fewer than two levels vertically higher than the base level 402 (e.g., one level, three levels, five levels, etc.). In some embodiments, the venue 400 includes more than one level vertically lower than the base level 402 (e.g., two levels, three levels, five levels, etc.). In other embodiments, the venue 400 does not include the lower level 408.

As shown in FIGS. 4-7, the base level 402, the second level 404, the third level 406, and the lower level 408 are separated by a ground surface, shown as floor 410. The venue 400 includes a concourse ramp (e.g., inclined walkway, access ramp, inclined roadway, etc.), shown as ramp 412, connected between the floors 410 of the base level 402, the second level 404, the third level 406, and the lower level 408 to facilitate access therebetween. By way of example, (i) people may walk up or down the ramp 412 and (ii) the vehicle 10 may travel up or down the ramp 412 to navigate between the base level 402, the second level 404, the third level 406, and the lower level 408.

The venue 400 includes areas (i) that should not be driven in with the vehicle 10, (ii) that require that the operator have certain credentials to drive in with the vehicle 10, (iii) that require that the vehicle 10 be a certain type of permitted vehicle, and/or (iv) that require attentive operation of the vehicle 10 by the operator (e.g., necessitates a reduced speed) because the areas include obstacles such as people walking, vendor and concession stands, storage areas, etc., for example. By way of example, these areas may include the base level 402, the second level 404, the third level 406, the lower level 408, the ramps 412 and/or one or more portions thereof. Driving in these areas with the vehicle 10 may be dangerous for an operator of the vehicle 10, be dangerous for people inside the venue 400 and surrounding the vehicle 10, damage the vehicle 10 and/or the venue 400, etc. Collectively, the areas that should not be driven in by the vehicle 10 are hereinafter referred to as restricted areas 414 (e.g., second restricted operation areas), and the areas that require attentive operation of the vehicle 10 by the operator are hereinafter referred to as limited operation areas 416 (e.g., first restricted operation areas). Accordingly, one or more three dimensional geofences (e.g., a virtual boundary, a virtual fence, a virtual box, etc.), shown as geofences 420, may be established around the restricted areas and the limited operation areas.

The geofences 420 may be three dimensional volumes or boundaries extending in x, y, and z coordinate directions and defined around the restricted areas 414 and/or the limited operation areas 416 to control and manage the operation of the vehicle 10 in the venue 400. By way of example, when the vehicle 10 is driven beyond the virtual boundary of the geofence 420 (i.e., driven into a restricted area 414 or a limited operation area 416), the operation of the prime mover 52 of the vehicle 10 may be limited (e.g., limit speeds below 5 miles per hour, prevent forward travel of the vehicle 10, limit the vehicle 10 to backward travel only, disabled, limited or restricted operation, etc.). Areas of the venue 400, such as designated vehicle routes on the base level 402, the second level 404, the third level 406, the lower level 408, and the ramps 412, an emergency access route, parking lots, garages, a playing field, etc. that are not restricted areas 414 (e.g., areas outside of the restricted areas 414) and that are not limited operation areas 416 (e.g., areas outside of the limited operation areas 416) defined by a geofence 420 may be drivable (e.g., navigable, permitted, unrestricted operation, etc.) by the vehicle 10, and are hereinafter referred to as drivable areas 422.

The site monitoring and control system 200 may control an operation of the operator controls 40, the driveline 50, the suspension system 60, the braking system 70, and/or any other component of the vehicle 10 based on a location (e.g., a GPS location, etc.) of the vehicle 10 relative to the restricted areas 414, the limited operation areas 416, and the drivable areas 422. By way of example, the site monitoring and control system 200 may determine, based on the location of the vehicle 10, that the vehicle 10 is operating (e.g., driving forward, driving backward, idling, stopped, parked, etc.) (i) in a drivable area 422, (ii) near a respective geofence 420 (e.g., within 5 yards of the respective geofence 420, within 10 yards of the respective geofence 420, etc.), (iii) in a limited operation area 416 defined by a respective geofence 420, or (iv) in a restricted area 414 defined by a respective geofence 420. In response to a determination that the vehicle 10 is operating in a drivable area 422, the site monitoring and control system 200 may facilitate (e.g., permit operation of the vehicle 10 in a first mode of operation) normal or unrestricted operation of the operator controls 40, the driveline 50, the suspension system 60, the braking system 70, and/or any other component of the vehicle 10. In response to a determination that the vehicle 10 is operating in or near a limited operation area 416 (e.g., near or in the geofence 420 defining a limited operation area 416), the site monitoring and control system 200 may (i) limit operation (e.g., limit operation of the vehicle 10 in a second mode of operation) of the operator controls 40, the driveline 50, the suspension system 60, the braking system 70, and/or any other component of the vehicle 10 and/or (ii) provide an indication (e.g., play a sound or message, display a warning message, illuminate one or more lights, etc. via the operator interface 48) to the operator that the vehicle 10 is operating in or near a limited operation area 416. By way of example, the site monitoring and control system 200 may limit operation of the prime mover 52 such that the vehicle 10 (i) cannot exceed a threshold speed (e.g., 5 miles per hour, 2 miles per hour, etc.), (ii) is limited to rearward travel, and/or (iii) any other control to limit operation of the vehicle 10. In response to a determination that the vehicle 10 is operating in or near a restricted area 414 (e.g., near or in the geofence 420 defining a restricted area 414), the site monitoring and control system 200 may (i) limit operation (e.g., limit operation of the vehicle 10 in a third mode of operation that is more limiting than the second mode of operation) of the operator controls 40, the driveline 50, the suspension system 60, the braking system 70, and/or any other component of the vehicle 10 and/or (ii) provide an indication (e.g., play a sound or message, display a warning message, illuminate one or more lights, etc. via the operator interface 48) to the operator that the vehicle 10 is operating in or near a restricted area 414. By way of example, the site monitoring and control system 200 may limit operation of the prime mover 52 such that the vehicle 10 (i) is limited to rearward travel, (ii) is shifted into neutral (e.g., such that no power is transmitted to the prime mover 52), and/or (iii) any other control to limit operation of the vehicle 10. In such an example, to transition the vehicle 10 to the second mode of operation or the third mode of operation, the site monitoring and control system 200 may (i) shift the vehicle 10 into neutral (e.g., such that no power is transmitted to the prime mover 52) and/or (ii) operate the braking system 70 to slow the vehicle 10 (e.g., to below the threshold speed, to a stop, etc.). The vehicle 10 may be limited to the second mode of operation or the third mode of operation until the vehicle 10 navigates (e.g., is navigated by an operator) to the drivable area 422.

As shown in FIG. 4, a geofence 420 is formed around the ramp 412 connecting the base level 402 with the second level 404. In such embodiments, everywhere except for the ramp 412 (e.g., the base level 402 and the second level 404) is a drivable area 422. As shown in FIG. 4, the ramp 412 extends in a vertical direction (i.e., a y-direction) between the floor 410 of the base level 402 and the floor 410 of the second level 404, in a horizontal direction (i.e., an x-direction) along the length of the ramp 412, and in a lateral direction (i.e., a z-direction extending into and/or out of the page) along a depth of the ramp 412. As shown in FIG. 4, the geofence 420 formed around the ramp 412 defines a limited operation area 416 such that when the vehicle 10 is driven beyond the virtual boundary of the geofence 420 (e.g., driven onto the ramp 412 from the floor 410 of the base level 402 or driven onto the ramp 412 from the floor 410 of the second level 404), the operation of the vehicle 10 is limited to the second mode of operation (e.g., such that the vehicle 10 cannot exceed a speed threshold). Accordingly, the operation of the vehicle 10 is limited or restricted when the vehicle 10 is operating on the ramp 412 (i.e., operating in the limited operation area 416 defined by the geofence 420). As shown in FIG. 4, the boundary of the geofence 420 (e.g., a vertical, y-coordinate, upper boundary) is established such that the area directly vertically above the ramp 412 on the second level 404 is a drivable area 422. In other words, the vehicle 10 operates in the first mode of operation (e.g., unrestricted operation) when being driven directly vertically above the ramp 412 and the geofence 420 established therearound.

Referring still to FIG. 4, in some embodiments, the geofence 420 formed around the ramp 412 defines a restricted area 414 such that when the vehicle 10 is driven beyond the virtual boundary of the geofence 420 (e.g., driven onto the ramp 412), the operation of the vehicle 10 is limited to the third mode of operation (e.g., such that operation of the prime mover 52 is disabled and the braking system 70 stops the vehicle 10). In such embodiments, the vehicle 10 operating on the base level 402 is restricted from driving onto the ramp 412 to navigate to the second level 404, and a vehicle 10 operating on the second level 404 is restricted from driving onto the ramp 412 to navigate to the base level 402, thereby restricting a second level vehicle to the second level 404 and a base level vehicle to the base level 402.

As shown in FIG. 5, a geofence 420 is formed around at least a portion of the second level 404 and defines a restricted area 414 such that when the vehicle 10 is driven beyond the virtual boundary of the geofence 420 (e.g., driven into the portion of the second level 404 around which the geofence 420 is formed), the operation of the vehicle 10 is limited to the third mode of operation. Accordingly, operation of the prime mover 52 is disabled and the braking system 70 stops the vehicle 10 when the vehicle 10 enters the restricted area 414. By way of example, the geofence 420 may be established around a portion of the second level 404 that is under construction, off-limits, not drivable, or restricted for any other reason such that (i) the vehicle 10 is operable in the first mode of operation in the drivable area 422 of the second level 404 (e.g., the remaining portions of the second level 404 that are not restricted by the geofence 420) and (ii) the vehicle 10 is operable in the third mode of operation in the restricted area 414 (e.g., operation of the prime mover 52 is disabled and the braking system 70 stops the vehicle 10). As shown in FIG. 5, the boundary of the geofence 420 (e.g., a vertical, y-coordinate, lower boundary) is established such that the area directly vertically below the geofence 420 on the base level 402 is a drivable area 422. In other words, the vehicle 10 operates in the first mode of operation when being driven directly vertically below the portion of the second level 404 around which the geofence 420 is established. In some embodiments, the geofence 420 formed around the portion of the second level 404 defines a limited operation area 416 such that the vehicle 10 is limited to the second mode of operation when the vehicle 10 is driven beyond the virtual boundary of the geofence 420. In some embodiments, the venue 400 of FIG. 5 additionally includes the geofence 420 described with respect to FIG. 4 and/or one or more other geofences 420.

As shown in FIG. 6, the geofence 420 is formed around (i) the ramp 412 extending between the second level 404 and the third level 406 and (ii) at least a portion of the third level 406. The geofence 420 defines a restricted area 414 such that when the vehicle 10 is driven beyond the virtual boundary of the geofence 420 (e.g., driven onto the ramp 412 from the second level 404 or driven into the portion of the third level 406 around which the geofence 420 is formed), the operation of the vehicle 10 is limited to the third mode of operation. In such embodiments, the base level 402, the ramp 412 extending between the base level 402 and the second level 404, the second level 404, and the remaining portions of the third level 406 that are not restricted by the geofence 420 are all drivable areas 422. By way of example, the vehicle 10 may freely navigate the base level 402, the ramp 412 extending between the base level 402 and the second level 404, and the second level 404, and a second vehicle 10 may freely navigate the remaining portions of the third level 406, but is restricted from navigating to the second level 404 via the ramp 412. In some embodiments, the geofence 420 formed around (i) the ramp 412 extending between the second level 404 and the third level 406 and (ii) the portion of the second level 404 defines a limited operation area 416 such that the vehicle 10 is limited to the second mode of operation when the vehicle 10 is driven beyond the virtual boundary of the geofence 420. In some embodiments, the geofence 420 vertically extends across more levels than the second level 404 and the third level 406. By way of example, the venue 400 may include six levels and the geofence 420 may vertically extend between all six levels (e.g., the geofence 420 may be formed around the ramp 412 extending between all six levels) such that operation of the vehicle 10 is limited (e.g., to the second mode of operation or the third mode of operation) when the vehicle 10 is driven beyond the virtual boundary of the geofence 420. In some embodiments, the venue 400 of FIG. 6 additionally includes the geofence 420 described with respect to FIG. 4, the geofence 420 described with respect to FIG. 5, and/or one or more other geofences 420.

As shown in FIG. 7, the venue 400 includes (i) a first geofence 420 formed around (a) the ramp 412 extending between the base level 402 and the second level 404 and (b) the second level 404, and (ii) a second geofence 420 formed around the lower level 408. In some embodiments, the first geofence 420 and the second geofence 420 are formed as a single geofence 420. As shown in FIG. 7, the first geofence 420 defines a restricted area 414 such that when the vehicle 10 is driven beyond the virtual boundary of the geofence 420 (e.g., driven onto the ramp 412 from the base level 402), the operation of the vehicle 10 is limited to the third mode of operation. Further, due to the first geofence 420 being formed around the second level 404 (e.g., the entirety of the second level 404), the vehicle 10 is prohibited from operating on the second level 404 (e.g., if the second level 404 is for pedestrians only, under construction, etc.). Similarly, as shown in FIG. 7, the second geofence 420 defines a restricted area 414 such that the vehicle 10 is prohibited from navigating to and operating on the lower level 408 (e.g., if the lower level 408 is for pedestrians only, under construction, etc.). In some embodiments, the first geofence 420 and/or the second geofence 420 define a limited operation area 416 such that the vehicle 10 is limited to the second mode of operation when the vehicle 10 is driven beyond the virtual boundary of the geofence 420. In some embodiments, the venue 400 of FIG. 7 includes one of first geofence 420 or the second geofence 420. In some embodiments, the venue 400 of FIG. 7 additionally includes the geofence 420 described with respect to FIG. 4, the geofence 420 described with respect to FIG. 5, the geofence 420 described with respect to FIG. 6, and/or one or more other geofences 420.

In some embodiments, the operation of the vehicle 10 is permitted or limited depending on the type of the vehicle 10. By way of example, if the vehicle 10 is an emergency vehicle, when the vehicle 10 crosses a boundary defined by a geofence 420, the vehicle 10 may be operable in the first mode of operation regardless of whether the geofence 420 defines a restricted area 414 or a limited operation area 416. In other words, the emergency vehicle may operate in an unrestricted manner such that the emergency vehicle can respond and navigate to a location of an emergency located anywhere throughout the venue 400. By way of another example, a first vehicle type may be limited to the second mode of operation responsive to crossing into a respective geofence 420 and a second vehicle type may be limited to the third mode of operation responsive to crossing the same respective geofence 420. In such an example, a smaller, lighter vehicle (i.e., a vehicle 10 of the first vehicle type) may be limited to the second mode of operation, while a larger, heavier vehicle (i.e., a vehicle 10 of the second vehicle type) may be limited to the third mode of operation responsive to crossing the same respective geofence 420 (e.g., to prevent larger and heavier vehicles 10 from operating at and navigating to higher levels of the venue 400).

In some embodiments, the operation of the vehicle 10 is permitted or limited depending on the credentials associated with the vehicle 10 and/or the credentials of the operator of the vehicle 10, thereby selectively restricting access to certain areas of the venue 400. By way of example, if the vehicle 10 is an emergency vehicle, when the vehicle 10 crosses a boundary defined by a geofence 420, the vehicle 10 may be operable in the first mode of operation regardless of whether the geofence 420 defines a restricted area 414 or a limited operation area 416. By way of another example, responsive to crossing into a geofence 420, (i) the vehicle 10 may be operable in the first mode of operation (or limited to the second mode of operation) if the operator of the vehicle 10 is authorized to enter the area defined by the geofence 420 or (i) the vehicle 10 may be limited to the third mode of operation if the operator of the vehicle 10 is not authorized to enter the area defined by the geofence 420.

In some embodiments, the operation of the vehicle 10 is permitted or limited depending on the time of day. By way of example, during the hours of operation of the venue 400, the geofences 420 established throughout the venue 400 may operate normally (e.g., either permitting or limiting operation of the vehicle 10 based on respective configurations of respective geofences 420) as discussed above with respect to FIGS. 4-7. By way of another example, outside the hours of operation of the venue 400, the geofences 420 established throughout the venue 400 may transition to define restricted areas 414 such that operation of the vehicle 10 is only permitted in the drivable areas 422. By way of yet another example, outside the hours of operation of the venue 400, a geofence 420 defining a restricted area 414 may be established around the entire venue 400 such that all vehicles 10 within the venue 400 are limited to the third mode of operation (e.g., inoperable). By way of yet another example, after hours, the limited operation area 416 may transition to drivable areas 422 with no restrictions (e.g., because there will be no pedestrian traffic).

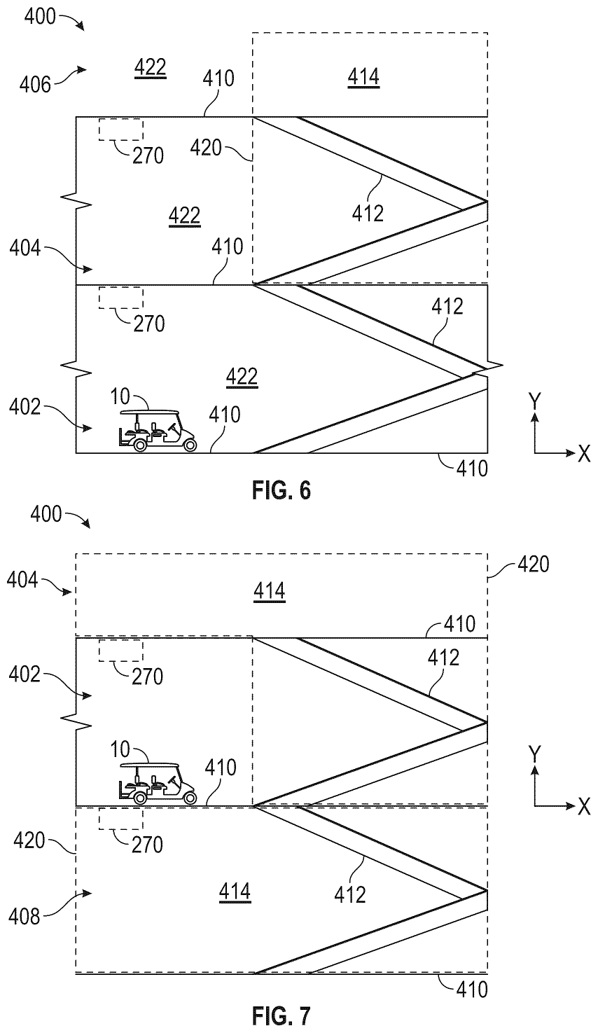

As shown in FIG. 8, the vehicle 10 is a golf cart driven by an operator playing golf on a golf course 500. The vehicle 10 may be a drink cart, a cart driven by an employee of the golf course 500 monitoring the pace of play of golfers, a cart driven by the maintenance crew working at the golf course 500, a golf cart driven by a golfer, or another type of vehicle or vehicle commonly found at golf courses (e.g., a turf mower, a sprayer, an aerator, a bunker rake, etc.). The golf course 500 is shown including a path (e.g., a trail, a cart route, etc.), shown as cart path 502, a passage (e.g., an underground passage), shown as tunnel 504, underneath a path (e.g., a road, a street, a highway, a cart route, etc.), shown as overpass 506. The tunnel 504 provides a passage for the cart path 502 to extend under the overpass 506, thereby preventing the need for the vehicle 10 to cross the overpass 506.

As shown in FIG. 8, a three dimensional geofence, shown as geofence 510, is formed around the tunnel 504 and the cart path 502 extending therethrough. The geofence 510 defines the limited operation area 416 and the drivable area 422. As shown in FIG. 8, the geofence 510 extends (i) longitudinally between an entrance of the tunnel 504 and an exit of the tunnel 504, (ii) vertically between the cart path 502 and the overpass 506, and (iii) laterally along the width of the cart path 502 and/or tunnel 504. The limited operation area 416 defined by the geofence 510 may include at least an interior volume defined by the tunnel 504. As shown in FIG. 8, the areas of the golf course 500 outside of the tunnel 504 such as the portions of the cart path 502 outside of the tunnel 504 and the overpass 506 above the tunnel 504 are drivable areas 422.

As shown in FIG. 8, a first vehicle 10 is navigating/operating within the limited operation area 416 such that, when the first vehicle 10 is driven beyond the virtual boundary of the geofence 510 (e.g., driven into or enters the tunnel 504), the operation of the first vehicle 10 is limited to the second mode of operation. A second vehicle 10 is shown navigating/operating on the overpass 506 outside of the limited operation area 416 (e.g., within the drivable area 522) such that normal or unrestricted operation of the second vehicle 10 is permitted. Accordingly, the second vehicle 10 operates in the first mode of operation (e.g., unrestricted operation) when being driven directly vertically above the tunnel 504 and the geofence 510 established therearound (e.g., when being driven on the overpass 506).

As shown in FIGS. 4-8, the venue 400 and the golf course 500 include one or more beacons 270 variously positioned thereabout to facilitate transmission of signals between the remote systems 240 and one or more of the vehicles 10. In some embodiments, an actual location of the vehicle 10 may be different than a tracked location of the vehicle 10 determined based on GPS data (e.g., collected by the sensors 90 and/or the user sensors 220). The error or difference between the tracked location of the vehicle 10 and the actual location of the vehicle 10 may be caused by signal interference (e.g., geomagnetic radiation), solar storms, signal obstruction (e.g., tree cover, building cover, etc.), weather (e.g., rain, snow, pressure, etc.), control system quality, malfunctioning sensors, and/or any other combination of internal hardware or external factors. The difference between the tracked location and the actual location may be referred to herein as location or GPS drift. Because of the difference between the tracked location and the actual location, the site monitoring and control system 200 may determine, based on the GPS position, that the vehicle 10 is operating in a restricted area 414 or a limited operation area 416 when in reality, the actual location of the vehicle 10 is not in the restricted area 414 or the limited operation area 416. In such an example, the site monitoring and control system 200 may undesirably limit the operation of the vehicle 10. Similarly, because of the difference between the tracked location and the actual location, the site monitoring and control system 200 may determine, based on the GPS position, that the vehicle 10 is not operating in the restricted area 414 or the limited operation area 416 (e.g., operating in the drivable area 422) when in reality, the actual location of the vehicle 10 is in the restricted area 414 or the limited operation area 416. In such an example, the site monitoring and control system 200 may undesirably permit operation of the vehicle 10 within the restricted area 414 or the limited operation area 416.

As shown in FIGS. 4-7, the venue 400 includes beacons 270 coupled with the floors 410 of the base level 402, the second level 404, and the third level 406. In some embodiments, the venue 400 includes more or fewer beacons 270 than shown in FIGS. 4-7 (e.g., one beacon 270 on each level of the venue 400, two or more beacons 270 variously positioned about each level of the venue 400, one beacon 270 for the entire venue 400, etc.). In some embodiments, the base level 402, the second level 404, the third level 406, and the lower level 408 are enclosed within the venue 400 causing a weak signal strength or no signal between the remote systems 240 and the vehicles 10, thereby making it difficult or impossible for the remote systems 240 to determine a position (e.g., based on GPS data, RTK data, etc. transmitted between the vehicles 10 and the remote systems 240) of the vehicles 10 within the venue 400. To account for the weak signal strength or no signal between the remote systems 240 and the vehicles 10, the beacons 270 retransmit signals from the remote systems 240 so that the signals are strong enough to reach the vehicles 10 and retransmit signals from the vehicles 10 so that the signals are strong enough to reach the remote systems 240.

As shown in FIG. 8, a beacon 270 is positioned at or proximate an entrance and/or exit of the tunnel 504. In some embodiments, the golf course 500 includes more or fewer beacons 270 located throughout the golf course 500. In some embodiments, when the vehicle 10 enters the tunnel 504, there may be a weak signal strength or no signal between the remote systems 240 and the vehicles 10, thereby making it difficult or impossible for the remote systems 240 to determine a position (e.g., based on GPS data, RTK data, etc. transmitted between the vehicles 10 and the remote systems 240) of the vehicles 10 within the tunnel 504. Traditionally, operators set geofences that are much larger than the area that they desire to limit operation within to account for GPS drift such that even if the tracked location is different than the actual location, the tracked location still falls within the larger area of the geofences. However, this technique may undesirably limit operation of a vehicle that is outside of the area that the operator desires to limit operation within because the geofence is made larger to account for GPS drift. According to an exemplary embodiment, to account for the weak signal strength or no signal between the remote systems 240 and the vehicles 10, the beacons 270 retransmit signals from the remote systems 240 so that the signals are strong enough to reach the vehicles 10 and retransmit signals from the vehicles 10 so that the signals are strong enough to reach the remote systems 240. In such embodiments, due to the communication between the vehicles 10 and the remote systems 240 being intermediated by the beacons 270 (e.g., due to the beacons 270 strengthening the signal between the vehicles 10 and the remote systems 240) the geofence 510 can be set by the operator that is adequately formed (e.g., not too large and not too small) around the area that they desire to limit operation within. By way of example, utilizing the beacons 270 may aid the remote systems 240 in determining the actual position of the vehicle 10 within the tunnel 504 such that the remote systems 240 do not (i) undesirably limit the operation of the vehicle 10 (e.g., within the drivable area 422) or (ii) undesirably permit operation of the vehicle 10 (e.g., within the restricted area 414 or the limited operation area 416).

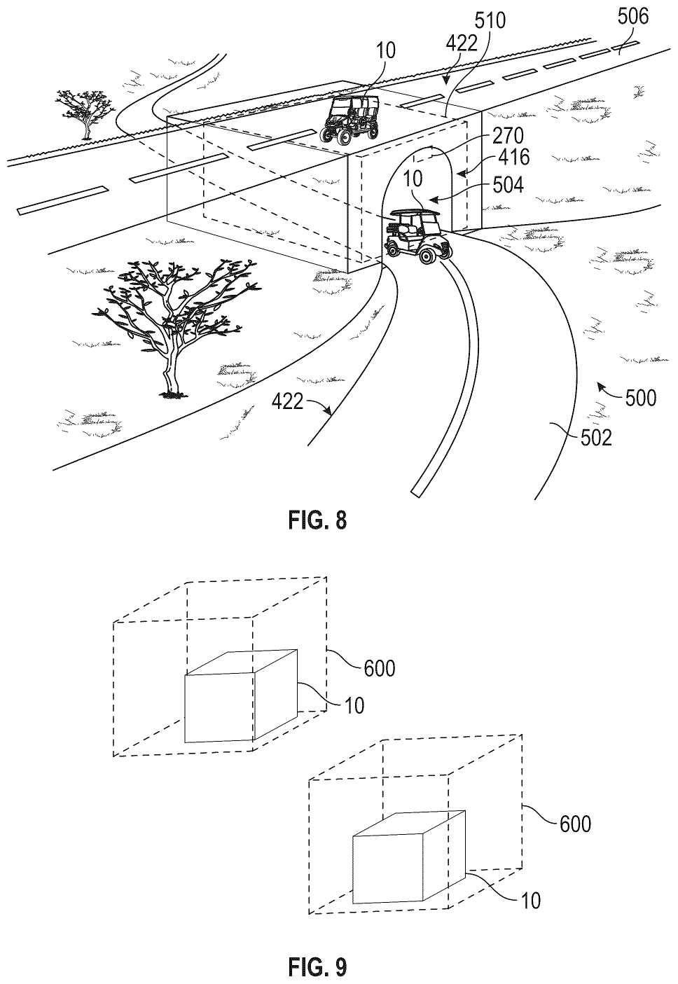

As shown in FIG. 9, a three dimensional geofence, shown as geofence 600, is formed around the vehicle 10 and configured to move with (e.g., follow) the vehicle 10 as the vehicle 10 is driven. By way of example, as the vehicle 10 drives, the geofence 600 remains formed around and positionally fixed relative to the vehicle 10. In some embodiments, the geofence 600 is cuboidally shaped (e.g., shaped like a cuboid), spherically shaped, or otherwise shaped to surround the vehicle 10. The geofence 600 may define a restricted area 414 or limited operation area 416 around the vehicle 10 such that responsive to another vehicle (e.g., a ground vehicle, an aerial vehicle, etc.) or object (e.g., a wall of the venue 400, a person, an obstacle, etc.) crossing the virtual boundary of the geofence 600 around the vehicle 10, operation of the vehicle 10 is limited to the second mode of operation or the third mode of operation until the other vehicle or object exits the area defined by the geofence 600. Generally, the geofence 600 prevents the vehicle 10 from driving too fast or operating altogether when the vehicle 10 comes close to another vehicle or an object. According to an exemplary embodiment shown in FIG. 9, a first geofence 600 is formed around a first vehicle 10 and a second geofence 600 is formed around a second vehicle 10. By way of example, when the first vehicle 10 enters the area defined by the second geofence 600, the operation of one or both of the first vehicle 10 and the second vehicle 10 is limited (e.g., to the second mode of operation or the third mode of operation). In such an example, the operation of the first vehicle 10 and the second vehicle 10 may be limited until the first vehicle 10 drives or flies away or the second vehicle 10 drives or flies away such that first vehicle 10 is no longer within the area defined by the second geofence 600. By way of another example, when the second vehicle 10 enters the area defined by the first geofence 600, the operation of one or both of the first vehicle 10 and the second vehicle 10 is limited (e.g., to the second mode of operation or the third mode of operation). In such an example, the operation of the second vehicle 10 and the first vehicle 10 may be limited until the second vehicle 10 drives or flies away or the first vehicle 10 drives away such that second vehicle 10 is no longer within the area defined by the first geofence 600.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A vehicle system comprising:
a vehicle including:
a chassis;
a plurality of tractive assemblies coupled to the chassis; and
a prime mover configured to drive one or more of the plurality of tractive assemblies; and
a control system configured to:
monitor a location of the vehicle relative to a restricted operation area;
permit unrestricted operation of the vehicle in a first mode of operation when the location of the vehicle indicates that the vehicle is located outside of the restricted operation area; and
limit operation of the vehicle to a second mode of operation or a third mode of operation when the location of the vehicle indicates that the vehicle is located in the restricted operation area,
wherein the restricted operation area is defined by one or more three dimensional geofences such that operation of the vehicle is permitted or limited based on a vertical position of the vehicle relative to the three dimensional geofence.

2. The vehicle system of claim 1, wherein limiting operation of the vehicle to the second mode of operation by the control system includes limiting operation of the prime mover such that the vehicle cannot exceed a threshold speed.

3. The vehicle system of claim 2, wherein limiting operation of the vehicle to the third mode of operation by the control system includes at least one of:
transmitting no power to the prime mover or applying brakes to stop the vehicle; or
limiting the vehicle to rearward travel only.

4. The vehicle system of claim 1, wherein the vehicle operates within a multi-level venue including:
a plurality of levels including at least a base level and a second level above the base level;
a floor separating each level of the plurality of levels; and
a ramp connecting the plurality of levels.

5. The vehicle system of claim 4, wherein the three dimensional geofence defining the restricted operation area is formed around the ramp connecting the base level and the second level such that the control system is configured to limit operation of the vehicle to the second mode of operation responsive to a determination that the vehicle has driven onto the ramp.

6. The vehicle system of claim 4, wherein the three dimensional geofence defining the restricted operation area is formed around the ramp connecting the base level and the second level such that the control system is configured to limit operation of the vehicle to the third mode of operation responsive to a determination that the vehicle has driven onto the ramp, thereby restricting the vehicle to the base level or the second level.

7. The vehicle system of claim 4, wherein the three dimensional geofence defining the restricted operation area is formed around a portion of a respective level of the plurality of levels such that the control system is configured to limit operation of the vehicle to the third mode of operation responsive to a determination that the vehicle has driven in the portion of the respective level, thereby restricting the vehicle to a remaining portion of the respective level.

8. The vehicle system of claim 4, wherein the three dimensional geofence is formed around a portion of a first respective level of the plurality of levels such that the control system is configured to:
limit operation of the vehicle responsive to a determination that the vehicle has driven in the portion of the first respective level; and
at least one of:
permit unrestricted operation of the vehicle responsive to a determination that the vehicle is vertically above the portion of the first respective level on a second respective level of the plurality of levels above the first respective level; or
permit unrestricted operation of the vehicle responsive to a determination that the vehicle is vertically below the portion of the first respective level on a third respective level of the plurality of levels below the first respective level.

9. The vehicle system of claim 4, wherein the three dimensional geofence is a first three dimensional geofence defining a first restricted operation area and formed around a first portion of the multi-level venue, and wherein a second three dimensional geofence defining a second restricted operation area is formed around a second portion of the multi-level venue.

10. The vehicle system of claim 4, wherein the control system includes a processing circuit located remote from the vehicle, further comprising a beacon configured to be positioned within the multi-level venue and configured to facilitate transmission of signals between the vehicle and the processing circuit.

11. The vehicle system of claim 1, wherein the vehicle operates on a golf course including:
a cart path;
an overpass; and
a tunnel under the overpass providing a passage for the cart path to extend under the overpass; and
wherein the three dimensional geofence defining the restricted operation area is formed around the tunnel such that the control system is configured to:
limit operation of the vehicle to the second mode of operation responsive to a determination that the vehicle has driven into the tunnel; and
permit unrestricted operation of the vehicle responsive to a determination that the vehicle is on the overpass vertically above the restricted operation area.

12. The vehicle system of claim 11, wherein the control system includes a processing circuit located remote from the vehicle, further comprising a beacon positioned at or proximate an entrance or an exit of the tunnel and configured to facilitate transmission of signals between the vehicle and the processing circuit within the tunnel.

13. The vehicle system of claim 1, wherein the control system is configured to selectively permit or limit operation of the vehicle responsive to a determination that the vehicle is located in the restricted operation area based on at least one of credentials associated with the vehicle or credentials associated with an operator of the vehicle.

14. The vehicle system of claim 1, wherein the control system is configured to selectively permit or limit operation of the vehicle responsive to a determination that the vehicle is located in the restricted operation area based on a type of the vehicle.

15. The vehicle system of claim 1, wherein the vehicle is a golf cart, emergency vehicle, an all-terrain vehicle, a utility task vehicle, lightweight or recreational vehicle, or a lawnmower.

16. The vehicle system of claim 1, wherein the control system includes one or more processing circuits including at least one of (a) a first processing circuit located on the vehicle or (b) a second processing circuit located remote from the vehicle.

17. A vehicle system for controlling operation of a vehicle, the vehicle system comprising:
one or more processing circuits comprising one or more memory devices coupled to one or more processors, the one or more memory devices configured to store instructions thereon that, when executed by the one or more processors, cause the one or more processors to:
monitor a location of the vehicle relative to a restricted operation area;
permit unrestricted operation of the vehicle in a first mode of operation when the location of the vehicle indicates that the vehicle is located outside of the restricted operation area; and
limit operation of the vehicle to a second mode of operation or a third mode of operation when the location of the vehicle indicates that the vehicle is located in the restricted operation area,
wherein the restricted operation area is defined by one or more three dimensional geofences such that operation of the vehicle is permitted or limited based on a vertical position of the vehicle relative to the three dimensional geofence.

18. The vehicle system of claim 17, wherein the vehicle operates within a multi-level venue including:
a plurality of levels;
a floor separating each level of the plurality of levels; and
a ramp connecting the plurality of levels,
wherein the three dimensional geofence is a first three dimensional geofence defining a first restricted operation area and formed around the ramp connecting a first level of the plurality of levels and a second level of the plurality of levels such that the instructions, when executed by the one or more processors, cause the one or more processors to limit operation of the vehicle to the second mode of operation responsive to a determination that the vehicle has driven onto the ramp, and
wherein a second three dimensional geofence defining a second restricted operation area is formed around a portion of a respective level of the plurality of levels such that the instructions, when executed by the one or more processors, cause the one or more processors to limit operation of the vehicle to the third mode of operation responsive to a determination that the vehicle has driven in the portion of the respective level, thereby restricting the vehicle to a remaining portion of the respective level.

19. The vehicle system of claim 17, wherein the vehicle operates on a golf course including:
a cart path;
an overpass; and
a tunnel under the overpass providing a passage for the cart path to extend under the overpass; and
wherein the three dimensional geofence defining the restricted operation area is formed around the tunnel such that the instructions, when executed by the one or more processors, cause the one or more processors to:
limit operation of the vehicle to the second mode of operation responsive to a determination that the vehicle has driven into the tunnel; and
permit unrestricted operation of the vehicle responsive to a determination that the vehicle is on the overpass vertically above the restricted operation area.

20. A vehicle system for controlling operation of a vehicle, the vehicle system comprising:
a non-transitory computer-readable medium having instructions stored thereon that, when executed by one or more processors, cause the one or more processors to:
monitor a location of the vehicle relative to a restricted operation area;
permit unrestricted operation of the vehicle in a first mode of operation when the location of the vehicle indicates that the vehicle is located outside of the restricted operation area; and
limit operation of the vehicle to a second mode of operation or a third mode of operation when the location of the vehicle indicates that the vehicle is located in the restricted operation area,
wherein the restricted operation area is defined by one or more three dimensional geofences such that operation of the vehicle is permitted or limited based on a vertical position of the vehicle relative to the three dimensional geofence.
